(19) United States
(12) Patent Application Publication
(10) Pub. No.: US 2025/0024779 A1
(43) Pub. Date: Jan. 23, 2025

(54) Mower

(71) Applicant: Allett Limited, Staffordshire (GB)

(72) Inventor: Shaun Etherington, Staffordshire (GB)

(21) Appl. No.: 18/706,883

(22) PCT Filed: Nov. 2, 2022
(86) PCT No.: PCT/GB2022/052761

§ 371 Date: May 2, 2024

(30) Foreign Application Priority Data
Nov. 2, 2021 (GB) 2115757.3
Feb. 28, 2022 (GB) 2202765.0

(51) Int. Cl. A01D 34/76; A01D 34/68; A01D 34/81; A01D 101/00

(52) U.S. Cl. CPC A01D 34/76; A01D 34/6812; A01D 34/81; A01D 2101/00

(57) ABSTRACT

There is provided a mower (100), comprising a mower housing. a removable cartridge (120) for interacting with a lawn. the cartridge (120) comprising a pulley (125), a motor for driving the cartridge (120), a drive assembly (300) configured to selectively engage with the cartridge pulley (125) comprising a drive belt (310) configured to connect the motor to the cartridge pulley, and a tension assembly (200) configured to apply tension to the drive belt (310) and to slacken at least a portion of the drive belt (310). Slackening the drive belt (310) releases the cartridge pulley (125) from the drive assembly (300).

### FIELD OF INVENTION

The present invention relates to a mower, in particular to a mower with a drive assembly configured to enable a change of mower cartridges.

### BACKGROUND OF THE INVENTION

Mowers are used extensively, both in the home and in public spaces, to maintain lawns. For larger areas of lawn, self-propelled mowers are typically used, especially in professional sport arenas, such as football, golf, cricket, bowls and the like.

Each of these uses may have different requirements or preferences. Mowers can be provided with an option for different cartridges to be fit to the mower in order to achieve different tasks without requiring a separate mower. For example, cartridges for a mower may include cutting cylinders with a range of blade numbers (e.g., a 6-blade cylinder and a 10-blade cylinder), verticut cylinder, scarifiers, lawn brushes or dethatchers. For proper treatment of a lawn, a combination of these tools should be used across a treatment and cutting cycle.

However, the changing of a cartridge is often an awkward and lengthy process and requires the removal and replacement of many parts. Several tools are also required to remove these parts, increasing the cost associated with doing so.

Additionally, the replaceable cartridges used in mowers are commonly driven by a gear wheel with plastic teeth. This is noisy during operation of the mower, and there is the potential for the wheel to break if not fitted correctly.

The present invention aims to at least ameliorate the aforementioned disadvantages associated with the prior art mowers.

### SUMMARY OF THE INVENTION

According to a first aspect of the present invention, there is provided a mower. The mower comprises: a mower housing; a removable cartridge for interacting with a lawn, the cartridge comprising a pulley; a motor for driving the cartridge; and a drive assembly. The drive assembly comprises a drive belt configured to connect the motor to the cartridge pulley; and a tension assembly configured to apply tension to the drive belt and to slacken at least a portion of the drive belt. Slackening the drive belt releases the cartridge pulley from the drive assembly. Applying tension to the drive belt retains the connection between the motor and the cartridge pulley.

Driving the cartridge with a drive belt and pulley arrangement advantageously provides a quieter driving mechanism than the plastic gear arrangement of the prior art. Further advantageously, the arrangement enables an easier removal of the cartridge from the mower—the act of slackening the drive belt releases the cartridge pulley by removing the contact between the drive belt and the cartridge pulley. As discussed above with reference to the prior art system, conventional mowers with replaceable cartridge often require removal of several parts (e.g. the gearing and interlocked parts) to replace a cartridge.

The tension assembly may comprise a tension pulley configured to contact the drive belt; and a tensioning lever configured to bias the tension pulley between a first and second position. At the first position, the drive belt is under tension and at the second position, the drive belt is slack.

Advantageously, the tension assembly comprising a lever and puller allows a user to apply the tension to the drive belt without requiring direct access to the drive assembly. Additionally, none of the parts that a user comes into contact with directly contact the drive belt. This arrangement improves the ease of replacement for a user and reduces the risk of a user damaging the drive assembly or themselves.

At the first position, the tension pulley is in contact with and pushing against the drive belt. This places the drive belt under tension and brings it into contact with the cartridge pulley. At the second position, the tension pulley is displaced from the drive belt, which slackens the belt and removes the contact with the cartridge pulley. This also displaces any drive components away from the cartridge pulley, which enables a user to remove the cartridge without the need to remove any of these components.

The tension pulley may be coupled to the tensioning lever with an arm, wherein the arm pivots about a fulcrum to bias the tension pulley between the first and second positions.

Using a pivoting action to bias the pulley between the first and second position is more convenient for a user. It is easier for a user to pull a lever towards themselves, using a lever and fulcrum than to push away or directly move the tension pulley. With the arrangement described, a user can advantageously apply the tension to the drive belt single-handedly.

The tension assembly may further comprise a quick release system. The quick release system may comprise a ratchet between the first and second position configured to prevent movement of the tension pulley from the first position to the second position. The quick release system may further comprise a quick release trigger configured to, on actuation, release the tension pulley from the ratchet and allow movement from the first position to the second position.

Advantageously, the ratchet prevents the tension pulley moving from the first position during use of mower. The tension pulley applies tension to the drive belt, so would be subject to a reactionary force from the drive belt. In use, this could lead to the tension pulley slipping from the first position towards the second position. The quick release system prevents this occurring. Additionally, the quick release system prevents a user moving the tension pulley without the trigger being actuated accidentally or otherwise.

The quick release system may further comprise a return spring configured to bias the tension pulley from the first position to the second position on release from the ratchet.

Advantageously, use of a return spring ensures that the tension pulley is moved to the second position. This ensures that the tension assembly and drive belt do not get left between the first and second position with the drive belt not sufficiently slackened for the cartridge to be removed. Additionally, this means that a user does not need to provide any significant force for the tension pulley to move to the second position. This improves the ease and speed of the replacement of the cartridge.

The mower may further comprise a locking assembly configured to clamp the removable cartridge in position as tension is applied to the drive belt.

Advantageously, the locking assembly prevents the cartridge slipping as the cartridge pulley comes into contact with the drive belt. A locking assembly reduces reduce risk of parts coming apart during use. This makes the mower safer to and reduces the likelihood of catastrophic failure of a part because a cartridge is not fitted properly, for example.

The locking assembly may comprise a cam lock mechanically coupled to the arm such that rotation of the arm rotates the cam lock.

Advantageously, integrating the clamping/locking of the cartridge in place with the tensioning of the drive belt into a single action for a user improves the ease of use. This is in stark contrast with prior art mowers, where several tools are required to remove and replace a cartridge. Further advantageously, this arrangement improves the safety of using the mower, because a user cannot apply tension to the drive belt (and therefore use the mower) without locking the cartridge in place.

Alternatively, the locking assembly may comprise a cam lock mechanically coupled to a separate locking lever. The cam lock may be mechanically coupled to the locking lever such that rotation of the locking lever rotates the cam lock.

The use of a separate locking lever maintains the advantage of improving the ease of use of the mower over prior art mowers. A user is not required to use any additional tools (specialist or otherwise) to lock and unlock the cartridge. A lever also contributes to a safer mower—the user has a visual prompt to indicate whether the cartridge is locked in place.

Both a combined and separate locking assembly as described advantageously do not require any gear mechanisms, maintaining the advantage of a quieter and smoother assembly with reduced wear on parts and lower likelihood of failure and replacement being required.

The mower may further comprise a safety switch configured to cut power to the motor when the removable cartridge is released from the drive assembly.

Advantageously, the safety switch prevents a user inadvertently driving the motor when the belt is slack (i.e. when the cartridge is released from the drive assembly). This reduces the risk of the drive assembly being damaged through improper use.

The movement of the tension pulley from the first to the second position may be the action that activates the safety switch.

Advantageously, this integrates the act of cutting power to the motor as a necessary step of removing a cartridge. In an embodiment, the single action of moving the tension pulley from the first to the second position may activate the safety switch and unclamp the cartridge from the locking assembly, where moving the tension pulley from the second to the first position clamps the cartridge in place and deactivates the safety switch. This ensures a user only has to perform a single action to unlock the cartridge and cut power to the motor and then to lock the cartridge and provide power to the motor. This reduces the number of steps required for removal and replacement of a cartridge, and decreases the time from fitting a new cartridge to the mower being usable again.

The mower housing may be configured to surround and conceal the drive assembly, such that a user does not have direct access to any of the moving parts without removal of a section of the mower housing. The mower housing may also be configured to at least partially enclose the removal cartridge, reducing a user's access to the cartridge. In an embodiment, a user may only have access to the tension lever and quick release trigger.

Advantageously, the mower housing surrounding the drive assembly and cartridge reduces access to the parts which may be easily damaged by a user, or which may compromise the safety of a user.

At least a portion of the drive belt may comprise teeth configured to engage with one or more of the pulleys. Advantageously, a toothed or “timing” belt provides reduced noise and weight in comparison to a gear and chain assembly. A toothed belt also reduces the risk of the belt slipping in use, and maintains high mechanical efficiency and a clean engagement of the pulleys with the drive belt. It is envisaged that alternative belts may be used, such as multi-rib or Poly V belts.

The tension assembly may further comprise a braking assembly configured to engage with the drive belt when the drive belt is slack. Advantageously, a braking assembly can prevent or at least reduce motion of the drive belt while a cartridge is being changed. A braking assembly also reduces the risk of the belt slipping during a this process.

The braking assembly may hold at least a portion of the drive belt in place when the drive belt is slack. The braking assembly may hold at least a portion of the drive belt in place when the mower is in the “safe” configuration.

The braking assembly may comprise a braking pulley configured to engage with the drive belt; and a braking member positioned proximate the drive belt and configured to prevent movement of at least a portion of the drive belt when the drive belt is slack. The braking member may be fixed relative to the body of the mower.

The braking pulley may be configured to retain contact with the drive belt when the drive belt is slack. Advantageously, the braking pulley can be used to move the drive belt away from the cartridge to enable the cartridge to be changed. If the drive belt disengaged from all pulleys when slack then there is a risk that the drive belt could inhibit a user's access to the cartridge, or get tangled and require refitting or cause damage.

The drive belt may be held between the braking pulley and the braking member to prevent movement of at least a portion of the drive belt when the drive assembly is disengaged from the cartridge pulley. Advantageously, this assists in preventing motion and slippage as mentioned previously. Further advantageously, this reduces the risk of the belt tangling when slack.

The tensioning lever may be configured to move the braking pulley to selectively allow engagement of the braking member and the drive belt. Advantageously, the use of a single lever to engage the braking member and reduce the tension in the belt improves ease of use of the mower. Further advantageously, braking and slackening of the belt simultaneously reduces the window in which the belt could slip or tangle.

The tensioning lever may be configured to move the braking pulley between:
(i) an engaged position, where the drive assembly is engaged with the cartridge pulley; and
(ii) a braking position, where the cartridge pulley is released from the drive assembly.

The braking pulley may coupled to the tensioning lever with an arm, wherein the arm pivots about a fulcrum to bias the braking pulley between the engaged and braking positions. As discussed with reference to the tension pulley, using a pivoting action is more convenient for a user. It is easier for a user to pull a lever towards and away from themselves than to push away or directly move the internal components. With the arrangement described, a user can advantageously apply the brake to the drive belt single-handedly (alongside reducing the tension in the belt).

The braking pulley and tension pulley may be positioned such that they have opposite lateral motion when the tension lever is moved. This retains some tension in the drive belt, and reduces the risk of the belt tangling. For example, motion of the lever away from the cartridge may move the tension pulley away from the cartridge and the braking pulley towards the cartridge. This allows for the belt to be lifted away from the cartridge—there is sufficient tension that the belt follows the tension pulley away from the cartridge rather than depositing on the cartridge pulley. Advantageously, this arrangement means that the slack portion of the drive belt may be retained between the tension pulley and the braking assembly. This reduces the likelihood of the slack belt being tangled in other possible components, such as a switch or a quick release system.

According to a second aspect of the present invention, there is provided a removable cartridge configured for use with the mower of any embodiment of the first aspect. The removal cartridge comprises a cartridge cylinder comprising one or more lawn tools, and a cartridge pulley coupled to the cylinder and configured to interact with the drive assembly, wherein rotation of the cartridge pulley rotates the cylinder.

The lawn tool may comprise one or more of cutting blades, scarifiers, verticut blades, lawn brushes or the like.

The advantages associated with the embodiments of the first aspects are also associated with that of the second aspect where appropriate.

According to a third aspect of the present invention there is provided a kit of parts suitable for assembling the mower of any embodiment of the first aspect.

The skilled man will appreciate that preferred features of any one embodiment and/or aspect of the invention may be applied to all other embodiments and/or aspects of the invention.

These and other aspects of the invention will be apparent from, and elucidated with reference to, the embodiments described hereinafter.

### BRIEF DESCRIPTION OF THE DRAWINGS

Embodiment of the invention shall now be described in detail by way of example and with reference to the accompanying drawings in which:

FIGS. 1a and 1b illustrate a mower according to an embodiment of the present invention;

FIGS. 2a, 2b and 2c illustrate the mower of FIGS. 1a and 1b in use, with the drive belt under tension and slack;

FIG. 3 illustrates a mower according to an alternative embodiment of the present invention; and

FIGS. 4a and 4b illustrate a mower according to an alternative embodiment of the present invention.

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar feature in modified and different embodiments.

### DETAILED DESCRIPTION OF EMBODIMENTS

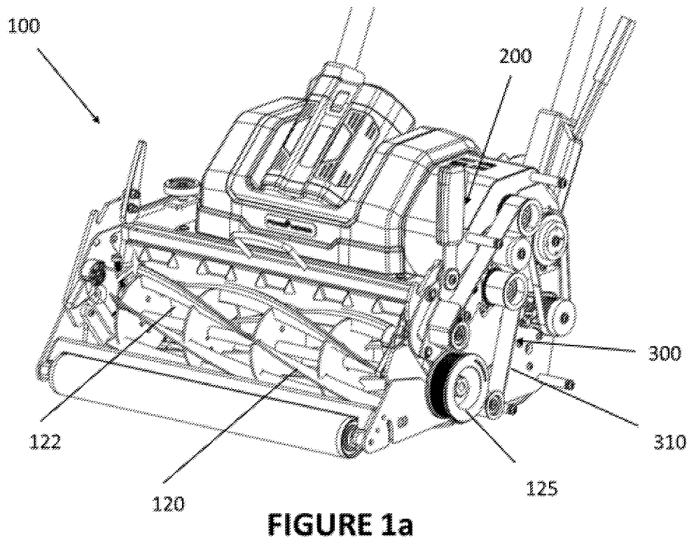

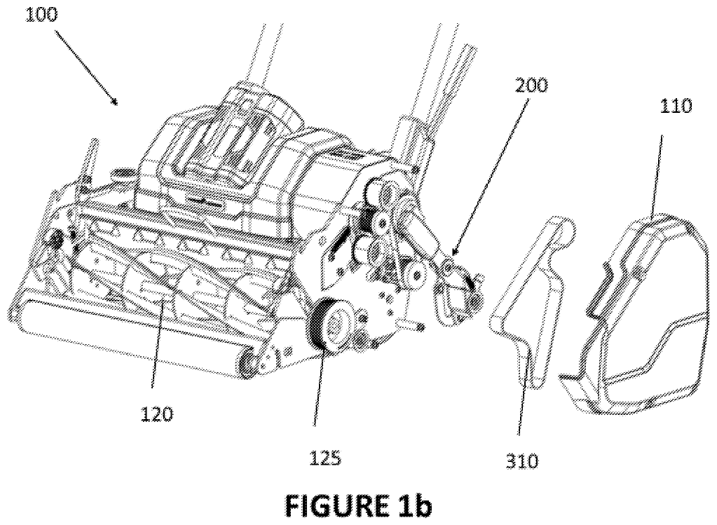

In an exemplary embodiment of the present invention, as shown in FIGS. 1a and 1b, there is provided a mower 100. The mower 100 includes a removable cartridge 120, which comprises a cylinder 122 coupled to a cartridge pulley 125. The cartridge pulley 125 is connected a drive assembly 300, which connects the cartridge pulley 125 to a motor with a drive belt 310. The drive belt 310 is tensioned to provide contact between the drive belt 310 and the cartridge pulley 125, enabling the cartridge pulley 125 to be driven by the motor. In the illustrated embodiment, the drive belt 310 wraps around a side of the cartridge pulley 125. Rotation of the motor drives the drive belt, which rotates the cartridge pulley 125. This in turn rotates the cylinder 122. In the illustrated embodiment, cylinder 122 comprises cutting blades, and so rotation of the cylinder 122 would enable the mower 100 to be used to cut a lawn.

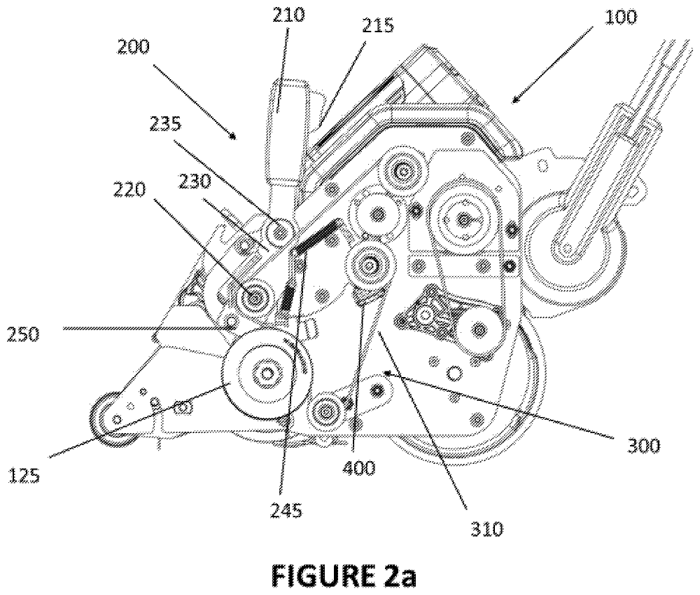

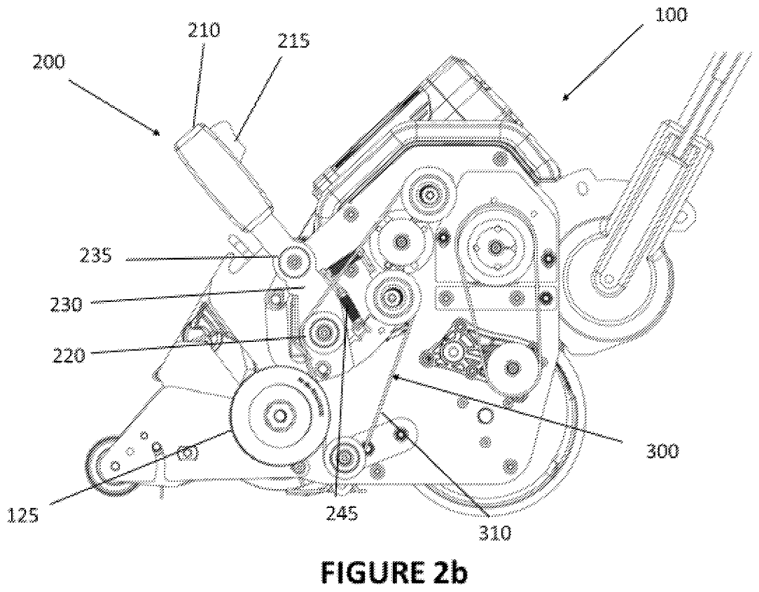

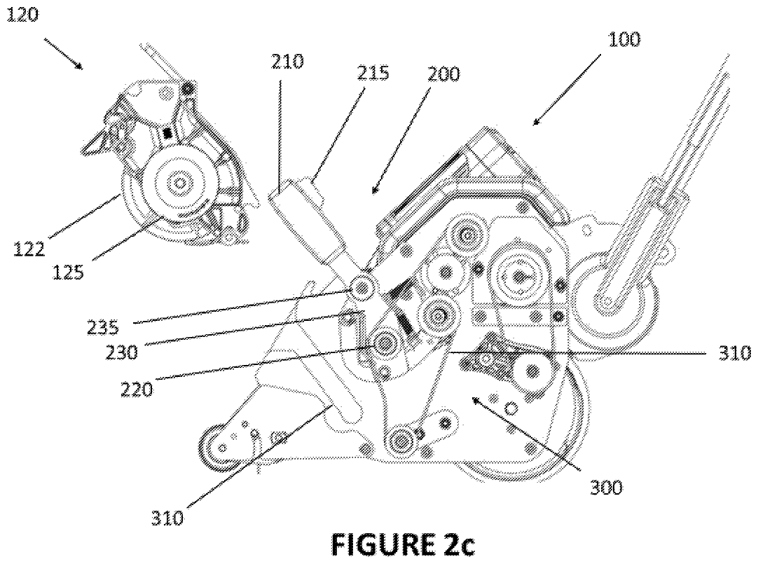

The drive belt 310 is tensioned by a tension assembly 200. The tension assembly 200 is also configured to slacken the drive belt 310. Slackening the drive belt 310 removes the contact between the drive belt 310 and the cartridge pulley 125. The tension assembly 200 is described in greater detail with reference to FIGS. 2a-c.

In the illustrated embodiment, cylinder 122 comprises cutting blades. It is envisaged that any appropriate lawn tools could be used in place of cutting blades, such as scarifiers, lawn brushes or dethatchers.

FIG. 1b illustrates the mower 100 of FIG. 1a, with components separated for clarity. FIG. 1b also illustrates mower side plate 110. Side plate 110 is configured to couple to the mower 100 and enclose the drive assembly 300, to prevent the user having access to moving parts while the mower 100 is in use.

FIGS. 2a to 2c illustrates a side view of mower 100 in three different stages of the removal of cartridge 120.

In FIG. 2a, the mower 100 is in a “use” or “on” configuration: the drive belt 310 is in contact with the cartridge pulley 125 and the motor can drive the cartridge 120, which is locked in place with locking assembly 250.

In FIG. 2b, the mower 100 is in a “safe” or “off” configuration. The drive belt 310 is slackened so it is no longer in contact with the cartridge pulley 125, and a safety switch 400 (visible in FIG. 2a) is activated, cutting power to the motor to prevent accidental use. The locking assembly 250 is unlocked.

In FIG. 2c, the cartridge 120 has been removed from the mower 100. As with FIG. 2b, the mower 100 is in “safe”/“off” configuration.

It is the movement of the tension assembly 200 that distinguishes between the on/off configurations. When the drive belt 310 is under tension from the tension assembly 200, the mower 100 is configured for use. When the tension assembly 200 is used to slacken the drive belt 310, the mower 100 is safe for removal of the cartridge 120.

Tension assembly 200 comprises a tension lever 210 and a tension pulley 220. The tension lever 210 and pulley 220 are coupled together with an arm 230, which is configured to pivot about a fulcrum 235. Movement of the lever 210 by a user biases the tension pulley 220 between a first position (the “on” configuration of FIG. 2a) and a second position (the “off” configuration of FIG. 2b/c). In the first position (FIG. 2a), the tension pulley 220 is pivoted towards the cartridge pulley 125 in contact with the drive belt 310 and applying a force to bias the drive belt 310 against the cartridge pulley 125. In the second position, the tension pulley 220 is pivoted away from the cartridge pulley 125. The biasing force is no longer acting on the drive belt 310 and the drive belt 310 is slackened.

Tension assembly 200 further comprises a quick release system, comprising a ratchet and a quick release trigger 215. The ratchet is disposed between the first and second positions and is configured to prevent the tension pulley 220 from moving from the first position to the second position. This stops the tension pulley 220 slipping due to the reaction force when tensioning the drive belt 310. The quick release trigger 215 is disposed on the tension lever 210 for easy access by a user and configured to release the tension pulley 220 from the ratchet, allowing the tension pulley 220 to move from the first position to the second position.

The quick release system further comprises a return spring 245. On the tension pulley 220 being released from the ratchet by the quick release trigger 215, the return spring 245 biases the tension pulley 220 towards the second position.

The mower 100 also includes a locking assembly 250. This locking assembly 250 is configured to clamp the cartridge 120 into place, to prevent the cartridge 120 coming away during use or the cartridge pulley 125 slipping out of contact with the drive belt 310. In the illustrated embodiment, locking assembly 250 comprises a cam lock. The cam lock is coupled to the arm 230 of tension assembly 200, such that movement of the tension pulley 220 from the first position to the second position transitions the locking assembly 250 from locked to unlocked and vice versa.

The mower 100 further includes a switch 400. The switch 400 is configured to cut power to the motor when the cartridge pulley 125 is released from the drive assembly 300. In the illustrated embodiment, the switch 400 is activated by contact from a member coupled to the arm 230 of the tension assembly 200. Movement of the tension pulley 220 from the first position to the second position (FIG. 2a to FIG. 2b) brings the member into contact with the switch 400, cutting the power to the motor. Conversely, when the tension pulley 220 moves from the second position to the first position, the member is no longer in contact with the switch 400 and so power can be supplied to the motor.

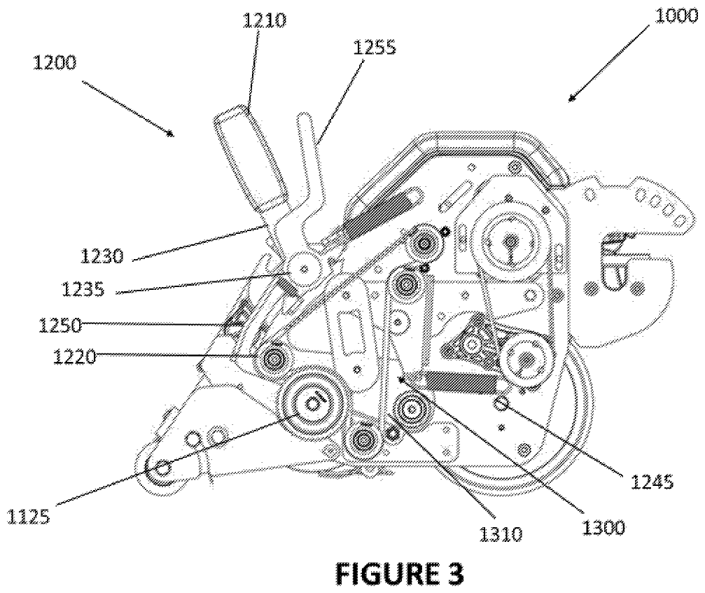

FIG. 3 illustrates an alternative mower according to the present invention. The mower 1000 of FIG. 3 is substantially similar to the mower 100 of FIGS. 1 and 2. This is depicted by the use of similar reference numerals (e.g. 1220 indicating the tension pulley of mower 1000). Mower 1000 differs from mower 100 in that the locking assembly 1250 is locked and unlocked separately to the tensioning of the drive belt 1310 by the tension assembly 1200. In the illustrated embodiment, a separate locking lever 1255 is provided. Movement of the locking lever 1255 in a first and second direction locks and unlocks the locking assembly 1255. In the illustrated embodiment, the locking lever 1255 and the tension lever 1210 rotate about the same fulcrum 1235, and the first and second directions of movement for map on to that of the tension lever 1210, for ease of use by an end user (i.e. the movement for slackening the drive belt 1310 and unlocking the locking assembly 1250 are in the same direction). It is envisaged that fully separate mechanisms could be used as an alternative.

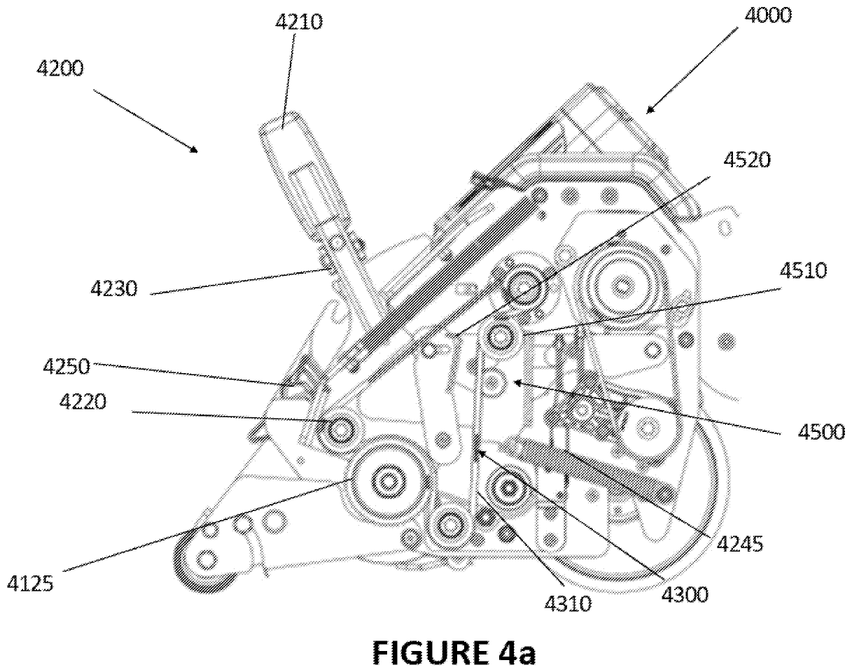

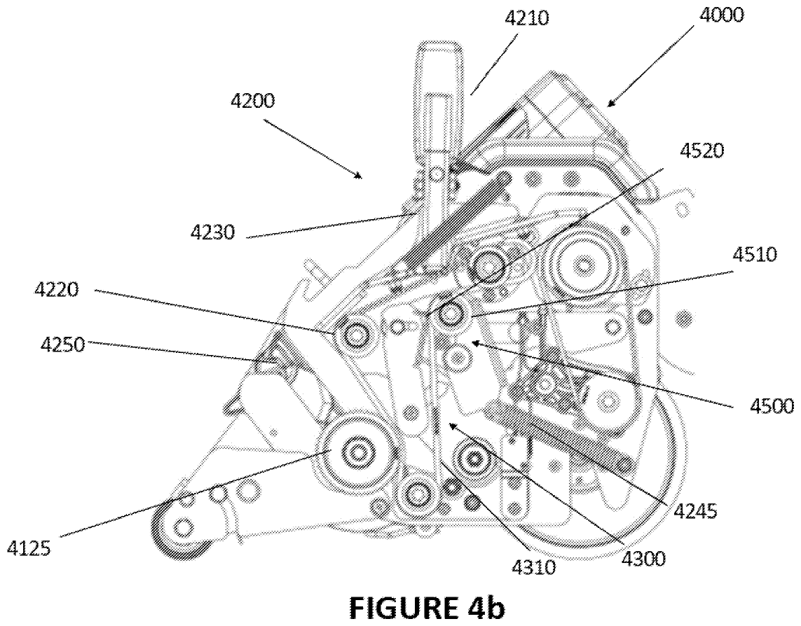

FIGS. 4a and 4b illustrate an alternative mower according to the present invention. Mower 4000 of FIGS. 4a and 4b is substantially similar to the mowers 100, 1000 of FIGS. 1 to 3. This is depicted by the use of similar reference numerals (e.g. 4220 indicating the tension pulley of mower 4000).

In FIG. 4a, the mower 400 is in a “use” or “on” configuration: the drive belt 4310 is in contact with the cartridge pulley 4125 and the motor can drive the cartridge 4120, which is locked in place with locking assembly 4250. In FIG. 4b, the mower 4100 is in a “safe” or “off” configuration. The drive belt 4310 is slackened so it is no longer in contact with the cartridge pulley 4125, and a safety switch 4400 (visible in FIG. 2a) is activated, cutting power to the motor to prevent accidental use. The locking assembly 4250 is unlocked.

Mower 4000 differs from the mowers 100, 1000 in that it further comprises a braking assembly 4500. Braking assembly 4500 comprises a braking pulley 4510 and a braking member 4520. Braking pulley 4510 is engaged with the drive belt 4310 both in the “use” and “safe” configurations. When the mower is in a “use” configuration, braking pulley 4510 is disposed away from the braking member 4520. mower 4100 is in a “safe” or “off” configuration, braking pulley 4510 is adjacent to the braking member 4520 such that the drive belt 4310 is held between the braking pulley 4510 and the braking member 4520. This prevents at least a portion of the drive belt 4310 moving during any replacement of the cartridge 120 (FIG. 1a).

Braking pulley 4510 also applies tension to the belt, as a sprung tensioner. Spring 4245 applies force to the braking pulley 4510, which in turn applies tension to the drive belt 4310. Without this arrangement, tension is provided by the manual alteration of the pulleys. Using pulley 4510 as a sprung tensioner therefore advantageously reduces the amount of preparation an end user is required to perform in order to change the cartridge of the mower 4000.

The addition of braking assembly 4500 also changes the relative positioning of tension pulley 4220 and its coupling with tension arm 4230. In the mowers 100, 1000 of FIGS. 1 to 3, tension pulley 220, 1220 is positioned such that the lateral movement of the tension pulley 220, 1220 is the opposite to that of tensioning lever 210, 1210 (i.e. motion of the tensioning lever 210, 1210 towards the cartridge pulley 125, 1125 moves tension pulley 220, 1220 away from the cartridge pulley 125, 1125). In the mower 4000 of FIG. 4, the components are positioned and coupled such that the lateral movement of the tension pulley 4220 and the tension lever 4210 are aligned (i.e. motion of the tensioning lever 4210 towards the cartridge pulley 4125 moves tension pulley 4220 towards from the cartridge pulley 4125).

Mower 4000 further differs in that at least a portion of drive belt 4310 is toothed. In the illustration of FIG. 4a this can be seen on the portion between the tension pulley 4220 and the braking pulley 4510. It may be that all of the drive belt 4310 is toothed. Mower 4000 further differs in that at least some of the pulleys (e.g. cartridge pulley 4125) are toothed, to engage cleanly with the drive belt 4310.

Features which are described in the context of separate embodiments may also be provided in combination in a single embodiment. Conversely, various features which are, for brevity, described in the context of a single embodiment, may also be provided separately or in any suitable subcombination. The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, a single processor or other unit may fulfil the functions of several means recited in the claims and reference signs in the claims shall not be construed as limiting the scope of the claims.

1. A mower comprising:
a mower housing;
a removable cartridge for interacting with a lawn, the cartridge comprising a pulley;
a motor for driving the cartridge;
a drive assembly configured to selectively engage with the cartridge pulley comprising a drive belt configured to connect the motor to the cartridge pulley; and
a tension assembly configured to apply tension to the drive belt and to slacken at least a portion of the drive belt, wherein slackening the drive belt releases the cartridge pulley from the drive assembly.

2. The mower of claim 1, wherein the tension assembly comprises:
a tension pulley configured to contact the drive belt; and
a tensioning lever configured to bias the tension pulley between a first and second position, wherein:
at the first position, the drive belt is under tension; and
at the second position, the drive belt is slack.

3. The mower of claim 2, wherein the tension pulley is coupled to the tensioning lever with an arm, wherein the arm pivots about a fulcrum to bias the tension pulley between the first and second positions.

4. The mower of claim 2, wherein the tension assembly further comprises:
a quick release system, comprising:
a ratchet between the first and second position, configured to prevent movement of the tension pulley from the first position to the second position; and
a quick release trigger configured to release the tension pulley from the ratchet and allow movement from the first position to the second position.

5. The mower of claim 4, wherein the quick release system further comprises:
a return spring configured to bias the tension pulley from the first position to the second position on release from the ratchet.

6. The mower of claim 1, further comprising:
a locking assembly, configured to clamp the removable cartridge in position as tension is applied to the drive belt.

7. The mower of claim 6, wherein the tension assembly comprises:
a tension pulley configured to contact the drive belt; and
a tensioning lever configured to bias the tension pulley between a first and second position, wherein:
at the first position, the drive belt is under tension; and
at the second position, the drive belt is slack; and
wherein the locking assembly comprises a cam lock mechanically coupled to the tensioning lever such that rotation of the tensioning lever rotates the cam lock.

8. The mower of claim 1, further comprising:
a safety switch configured to cut power to the motor when the removable cartridge is released from the drive assembly.

9. The mower of claim 8, wherein the tension assembly comprises:
a tension pulley configured to contact the drive belt; and
a tensioning lever configured to bias the tension pulley between a first and second position, wherein:
at the first position, the drive belt is under tension; and
at the second position, the drive belt is slack; and
wherein the movement of the tension pulley from the first to the second position activates the safety switch.

10. The mower of claim 1, wherein the mower housing is configured to surround and conceal the drive assembly and at least partially enclose the removal cartridge.

11. The mower of claim 1, wherein at least a portion of the drive belt comprises teeth configured to engage with one or more of the pulleys.

12. The mower of claim 1, wherein the tension assembly further comprises a braking assembly configured to engage with the drive belt when the drive belt is slack.

13. The mower of claim 12, wherein the braking assembly holds at least a portion of the drive belt in place when the drive belt is slack.

14. The mower of claim 12, wherein the braking assembly comprises:
a braking pulley configured to engage with the drive belt; and
a braking member positioned proximate the drive belt and configured to prevent movement of at least a portion of the drive belt when the drive belt is slack.

15. The mower of claim 14, wherein:
the braking pulley is configured to retain contact with the drive belt when the drive belt is slack.

16. The mower of claim 14, wherein the drive belt is held between the braking pulley and the braking member to prevent movement of at least a portion of the drive belt when the drive assembly is disengaged from the cartridge pulley.

17. The mower of claim 14, wherein the tension assembly comprises:
a tension pulley configured to contact the drive belt; and
a tensioning lever configured to bias the tension pulley between a first and second position, wherein:
at the first position, the drive belt is under tension; and
at the second position, the drive belt is slack; and
wherein the tensioning lever is configured to move the braking pulley to selectively allow engagement of the braking member and the drive belt.

18. The mower of claim 14, wherein the tension assembly comprises:
a tension pulley configured to contact the drive belt; and
a tensioning lever configured to bias the tension pulley between a first and second position, wherein:
at the first position, the drive belt is under tension; and
at the second position, the drive belt is slack; and
wherein the tensioning lever is configured to move the braking pulley between:
(i) an engaged position, where the drive assembly is engaged with the cartridge pulley; and
(ii) a braking position, where the cartridge pulley is released from the drive assembly.

19. The mower of claim 18, wherein braking pulley is coupled to the tensioning lever with an arm, wherein the arm pivots about a fulcrum to bias the braking pulley between the engaged and braking positions.

20-22. (canceled)
